(19) United States
(12) Patent Application Publication
(10) Pub. No.: US 2026/0346320 A1
(43) Pub. Date: Nov. 5, 2026

(54) OPTIMIZED TABLE FOR A BENDING MACHINE

(71) Applicant: TRUMPF Maschinen Austria GmbH & Co. KG., Pasching (AT)

(72) Inventor: Florian HAUSMANN, Traun (AT)

(73) Assignee: TRUMPF Maschinen Austria GmbH & Co. KG., Pasching (AT)

(21) Appl. No.: 19/124,441

(22) PCT Filed: Nov. 16, 2023
(86) PCT No.: PCT/AT2023/060397

§ 371 Date: Apr. 25, 2025

(30) Foreign Application Priority Data
Nov. 17, 2022 (AT) A50872/2022

(51) Int. Cl. B21D 5/02

(52) U.S. Cl. CPC B21D 5/0272; B21D 5/0281

(57) ABSTRACT

In a bending machine and a manufacturing method for bending machines, the bending machine manufactures sheet metal workpieces in a bending-pressing or folding-pressing operation and includes at least one machine frame, a machine table, and a pressing beam. The table includes a beam-like supporting structure that is fixed on a contact surface, extends along a longitudinal direction, and is connected to the frame at its end regions that are spaced from one another in the longitudinal direction. The supporting structure includes at least one lower chord element and at least one web element forming a one-piece welded construction. The one-piece welded construction of bending machines, which are manufactured using the manufacturing method, is designed or constructed for each machine so that for machines with a substantially identical table length and possibly different pressing forces, a first support surface of the table undergoes substantially identical deformations during the bending-pressing operation.

The invention relates to a bending machine for manufacturing from sheet metal by forming in a bending-pressing operation or a folding-pressing operation with a specially designed machine table, as well as to a method for manufacturing bending machines corresponding to the bending machine according to the invention.

A folding press is known from EP 2509724 B1, in which the side faces, the lower beam and the upper beam are assembled from separate plate, plate stack and/or bar parts, contain tension elements which absorb tensile stresses, press elements which absorb pressing stresses, and transmission elements between tension elements and press elements for transmitting forces between them, the tension elements, the press elements and the transmission elements being connected to one another by mechanical connecting elements without welding.

The structure of a bending machine known from this document, in particular the structure of the machine table or the pressing beam of the bending machine, has the disadvantage that the deformation behavior of the machine table can only be influenced to a limited extent by the structure of the machine table due to the pressing forces during the folding-pressing operation and therefore an individual wedge crowning must be provided for each folding length and machine tonnage to compensate for the deformations.

The object of the present invention was to overcome the disadvantages of the prior art and to provide a device and a method by means of which the deformation behavior of the machine table and the pressing beam is (being) improved.

This object is achieved by a device and a method according to the claims.

The bending machine according to the invention for producing workpieces from sheet metal by forming in a bending-pressing operation or a folding-pressing operation, comprises
a machine frame comprising two frame faces spaced apart from one another in a longitudinal direction, wherein respective outer surfaces of the frame faces are aligned normal to the longitudinal direction,
a machine table comprising a beam-like supporting structure, the beam-like supporting structure being fixed on a contact surface, extending along the longitudinal direction and being connected to a respective frame face of the machine frame at its end regions which are spaced apart from one another in the longitudinal direction,
a pressing beam adjustable along guide arrangements on the machine frame and aligned along the longitudinal direction, the pressing beam being adjustable in the direction towards and away from the machine table by at least one drive means,
a first support surface on the machine table and a second support surface, opposite the first support surface, on the pressing beam for bending tools and/or for tool holding devices which can be fitted with bending tools,
characterized in that
the beam-like support structure comprises at least one lower chord element and at least one web element, which at least one lower chord element and which at least one web element form a one-piece welded construction.

The machine table or the bending tools supported on the machine table are used to support a workpiece to be produced during the folding-pressing operation. Therefore, the machine table must have a certain rigidity and load-bearing capacity in accordance with the resulting loads in order to ensure that the workpieces to be produced can be bent or folded. The forces are absorbed by the supporting structure or the beam-like supporting structure of the machine table.

The rigidity of the supporting structure or the beam-like supporting structure is influenced to a greater extent by the mass components of the supporting structure that are further away from the center of mass of the supporting structure than by those that are closer to the center of mass. The configuration of the supporting structure according to the invention thus makes it possible, on the one hand, to save weight and thus manufacturing costs compared to a one-piece machine table made of solid sheet metal or compared to a solid material machine table, while, on the other hand, the rigidity of the supporting structure or of the machine table is further ensured by the provision of a one-piece welded construction comprising at least one lower chord section and a web section in accordance with the requirements of the production plant.

In general, the one-piece welded construction may be formed or welded together from individual elements, wherein the individual elements has not only to comprise a lower chord element and a web element, but may also comprise other individual elements.

In this way, a desired or required deformation behavior of the beam-like supporting structure or the machine table can be set by appropriately dimensioning the individual elements of the supporting structure and its welded joints. In particular, by appropriately dimensioning the individual elements of the supporting structure and its welded joints, it is possible to set a desired and essentially identical or almost identical deformation behavior of the supporting structure for a bending length of bending machines with different machine tonnages or with different pressing forces. This has the synergetic advantage that a wedge crowning of the same design or at least with the same requirements can be used for bending machines with the same or at least approximately the same bending length and different machine tonnages.

Furthermore, it may be useful if the beam-like supporting structure also comprises at least one upper chord element which forms the one-piece welded construction with the at least one web element. This allows the deformation behavior or the rigidity of the beam-like supporting structure to be further improved or better adapted to the requirements of the bending machine.

Furthermore, it may be provided that a cross-sectional plane is defined normal to the longitudinal direction, and that the upper chord element in the cross-sectional plane has an upper chord element width in the direction parallel to the contact surface, wherein the upper chord element width in the cross-sectional plane is greater than a web element width in the direction parallel to the contact surface of the at least one web element, wherein the upper chord element width is in particular 1.5 times to 5 times the web element width. This ensures that the mass fractions of the sections of the supporting element further away from the center of mass of the supporting structure are increased in order to have a beneficial effect on the rigidity of the machine table.

In addition, it may be provided that a cross-sectional plane is defined normal to the longitudinal direction, and that the lower chord element in the cross-sectional plane has a lower chord element width in the direction parallel to the contact surface, wherein the lower chord element width in the cross-sectional plane is greater than a web element width in the direction parallel to the contact surface of the at least one web element, wherein the lower chord element width is in particular 1.5 times to 5 times the web element width. This ensures that the mass fractions of the sections of the supporting element further away from the center of mass of the supporting structure are increased in order to have a beneficial effect on the rigidity of the machine table. The beam-like supporting structure is therefore also essentially constructed like an I-beam, or at least its cross-section is similar to an I-beam, which is a proven and easy-to-produce form, particularly in manufacturing the same.

Another advantageous embodiment is one according to which it may be provided that a cross-sectional plane is defined normal to the longitudinal direction, and that the at least one web element in the cross-sectional plane has a web height in the direction normal to the contact surface, wherein the web height in the cross-sectional plane is greater than a lower chord height in the direction normal to the contact surface, wherein the web height is in particular 2 to 10 times the lower chord height.

Analogically, it may be provided that a cross-sectional plane is defined normal to the longitudinal direction, and that the at least one web element in the cross-sectional plane has a web height in the direction normal to the contact surface, wherein the web height in the cross-sectional plane is greater than an upper chord height in the direction normal to the contact surface, wherein the web height is in particular 2 to 10 times the upper chord height.

This ensures that the mass fractions of the sections of the supporting element further away from the center of mass of the supporting structure are increased in order to have a beneficial effect on the rigidity of the machine table.

According to an advancement, it is conceivable that the beam-like supporting structure comprises an odd number, in particular three, five or seven, preferably three, of web elements arranged in a row in the longitudinal direction, which web elements form the one-piece welded construction. This allows the rigidity of the beam-like supporting structure to be controlled in the longitudinal direction, further reducing the overall weight of the machine table or bending machine.

Furthermore, it may be useful if a cross-sectional plane is defined normal to the longitudinal direction, and that the web elements which are closest to the end regions of the beam-like supporting structure have a smaller web element width in the cross-sectional plane in the direction parallel to the contact surface than the web element arranged centrally in the longitudinal direction of the beam-like supporting structure. This makes it possible to increase the transverse stability of the beam-like supporting structure in the central area, which in turn means that the width of the web elements may be reduced for the other web elements, depending on the machine tonnage, while still achieving the same or essentially similar deformation behavior in the folding-pressing operation. This can also save weight, making the manufacture of such a bending machine more economical.

In addition, the web elements may be arranged at a distance from each other in the longitudinal direction. This can also save weight, even though the web elements arranged in a row can still be used to achieve the intended deformation behavior.

Furthermore, it may be provided that the machine table comprises at least one plate element, wherein the at least one plate element is arranged on a first longitudinal side of the beam-like supporting structure, which first longitudinal side is opposite a second longitudinal side of the beam-like supporting structure, and which second longitudinal side is assigned closest to the machine frame, and that the at least one plate element covers the beam-like supporting structure at least in sections and can be connected to the beam-like supporting structure by means of at least one fastening means, preferably detachable as required, such as a plurality of screws. The provision of at least one plate element may also give the operator of the bending machine the familiar appearance of a solid machine table with a beam-like supporting structure made of a plate, which gives the operator a feeling of increased safety of the bending machine. Furthermore, the plate element also protects the individual elements of the beam-like supporting structure from soiling. The plate element or its specific configuration may also serve as an indicator for a possible excessive stress on the beam-like supporting structure and, as a result, plastic deformation of the plate element.

According to a particular embodiment, it is conceivable that the machine table comprises several plate elements that are spaced apart in the longitudinal direction and arranged on the first longitudinal side of the beam-like supporting structure. On the one hand, this facilitates the assembly of the machine table during the manufacture of the bending machine and, on the other hand, allows different plate elements to be arranged in a row in their geometric dimensions in the longitudinal direction. The connection with the respective fasteners may thus contribute to the strength of the beam-like supporting structure.

According to an advantageous advancement, it may be provided that at least one plate element comprises a holding or guiding device for at least one additional unit, wherein the at least one additional unit is selected from the group consisting of workpiece supporting unit, bending angle measuring device and workpiece support. Conveniently, for example, a bending angle measuring device may be positioned on the holding or guiding device of the at least one plate element, which can also be displaced in the longitudinal direction along the holding or guiding device. This increases the functionality of at least one plate element. In combination with the possibility that several plate elements arranged in a row in the longitudinal direction can be provided, a bending machine with different working areas arranged in a row in the longitudinal direction can be equipped with a correspondingly necessary additional unit for each working area. This increases the usability of the bending machine and the shapes of workpieces that can be produced or manufactured with it, which subsequently improves the degree of utilization and accordingly the cost-effectiveness of the bending machine. Furthermore, the advantage may be achieved that a bending machine can also be sold without a plate element, wherein a plate element or even several plate elements with different additional units may be coupled to the bending machine as an extension of the bending machine, so that its range of functions may be extended and adapted. Above all, this brings economic advantages both in the production of the bending machine and in the use of the bending machine in a manufacturing plant for workpieces.

In particular, it may be advantageous if the machine table comprises an adjusting device for actively adjusting the first support surface between a substantially flat and a crowned course of the support surface, wherein the first support surface is formed by a first beam element of the machine table and is supported on the beam-like supporting structure. The adjusting device may for example be a wedge crowning. The advantage here is that for a certain bending length of the bending machine, a series of adjusting devices or essentially identical adjusting devices can be used for several bending machines with different machine tonnage or with different bending forces, provided that they are appropriately designed in conjunction with the beam-like supporting structure.

Furthermore, it may be provided that the pressing beam comprises a pressing beam supporting structure, which pressing beam supporting structure, like the beam-like supporting structure, is configured as a further one-piece welded construction. As the pressing beam and the machine table generally exhibit deformations during the folding-pressing operation, the deformation behavior of the pressing beam can also be influenced according to the welded construction made of individual elements. This in turn reduces the weight of the bending machine, which lowers the manufacturing costs of the bending machine.

In addition, it may be provided that the pressing beam comprises a second adjusting device for actively adjusting the second support surface between a substantially flat and a crowned course, wherein the second support surface is formed by a second beam element of the pressing beam and is supported on the pressing beam supporting structure. Since the pressing beam supporting structure as well as the beam-like supporting structure are each designed as a one-piece welded construction, an essentially uniform deformation behavior of the respective supporting structure can be set. This makes it possible, for example, for the adjusting device and the second adjusting device for a specific bending length of the bending machine to be essentially identical in design. This reduces the manufacturing costs of the bending machine.

The invention also relates to a method for manufacturing bending machines. In this respect, a bending machine comprises
a machine frame comprising two frame faces spaced apart in a longitudinal direction, wherein respective outer surfaces of the frame faces are aligned normal to the longitudinal direction,
a machine table with a machine table length in the longitudinal direction, the machine table comprising a beam-like supporting structure, the beam-like supporting structure being positioned fixedly on a contact surface, extending along the longitudinal direction and being connected to a respective frame face of the machine frame at its end regions spaced apart in the longitudinal direction,
a pressing beam adjustable along guide arrangements on the machine frame and aligned along the longitudinal direction and having a pressing beam length extending in the longitudinal direction, the pressing beam being adjustable with at least one drive means in the direction towards and away from the machine table,
a first support surface on the machine table and a second support surface on the pressing beam opposite the first support surface, in each case for bending tools and/or for tool holding devices which can be fitted with bending tools,
   characterized in that
the beam-like supporting structure is formed from individual elements, which individual elements comprise at least one lower chord element and at least one web element, a one-piece welded construction being formed from the individual elements by welding the individual elements together, and
the individual elements of the one-piece welded construction of bending machines with a substantially identical machine table length are dimensioned in such a way that the first support surface has a substantially identical deformation of the first support surface or a substantially identical sum deformation of the first support surface and the second support surface during the bending-pressing operation or the folding-pressing operation, independently of the pressing forces which can be applied by means of the drive means of the bending machine.

The advantage is that the individual elements can be easily welded together to form a one-piece welded construction, although the beam-like supporting structure can be produced by selecting the individual elements in such a way that a uniform or essentially identical deformation behavior can be set for bending machines with different machine tonnage or with different bending forces and with the same bending length during the folding-pressing operation. This enables the use of essentially identical adjusting devices or wedge crowning devices. The manufacturing costs are thus reduced by the use of a series of adjusting devices and by the reduction in weight due to the replacement of the solid panels normally used by the beam-like supporting structure or the one-piece welded construction.

Furthermore, it may be useful if an upper chord element is provided as a further individual element for the one-piece welded construction. This allows the deformation behavior or the rigidity of the beam-like supporting structure to be further improved or better adapted to the requirements of the bending machine.

Furthermore, it may be provided that additional web elements are provided as further individual elements for the one-piece welded construction, wherein a total of three, five or seven web elements arranged in a row in the longitudinal direction are provided for the one-piece welded construction. This allows the rigidity of the beam-like supporting structure to be controlled in the longitudinal direction, further reducing the overall weight of the machine table or bending machine.

An embodiment is also advantageous, according to which it may be provided that the pressing beam comprises a pressing beam supporting structure, which pressing beam supporting structure, like the beam-like supporting structure, is configured as a further one-piece welded construction of individual elements, the individual elements of the further one-piece welded construction being dimensioned by bending machines having a substantially identical pressing beam length in such a way that the second support surface has a substantially identical deformation of the second support surface or a substantially identical sum deformation of the first support surface and the second support surface during the bending-pressing operation or the folding-pressing operation, independently of a pressing force that can be applied by means of the drive means of the bending machine, and that the individual elements are welded together to form a further one-piece welded construction. Since the pressing beam supporting structure as well as the beam-like supporting structure are each configured as a one-piece welded construction, an essentially uniform deformation behavior of the respective supporting structure can be set. This makes it possible, for example, for the adjusting device and the second adjusting device for a specific bending length of the bending machine to be essentially identical in design. This reduces the manufacturing costs of the bending machine.

For a better understanding of the invention, it is explained in more detail with the aid of the following figures.

The figures show a simplified, schematic representation as follows:

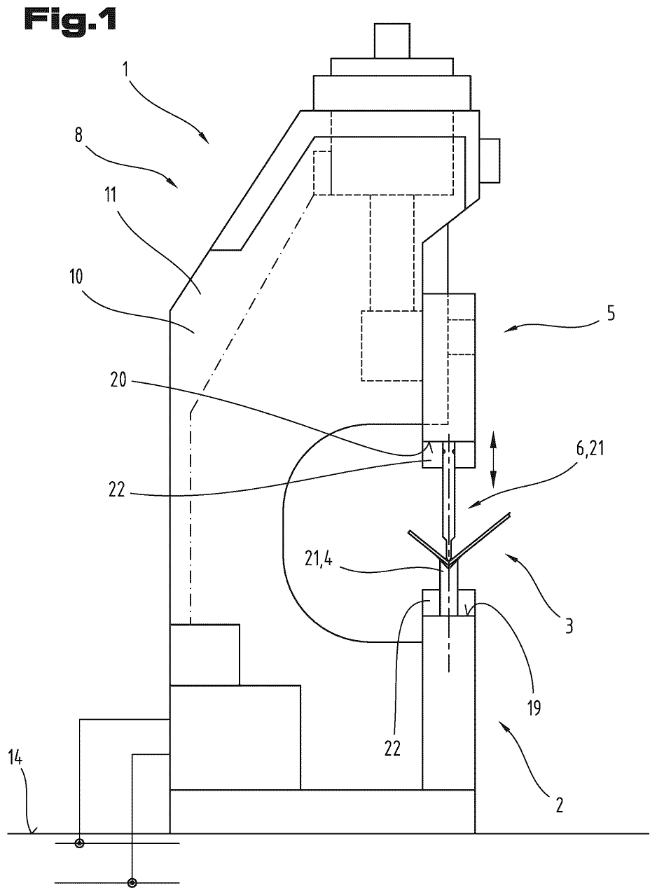

FIG. 1 a bending machine;

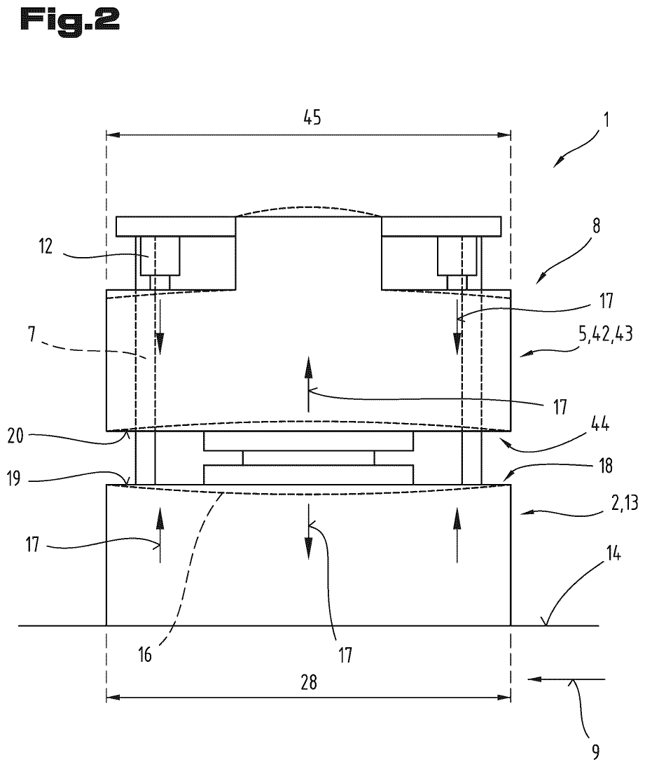

FIG. 2 a view of a bending machine as shown in FIG. 1 with deformations occurring during the folding-pressing operation;

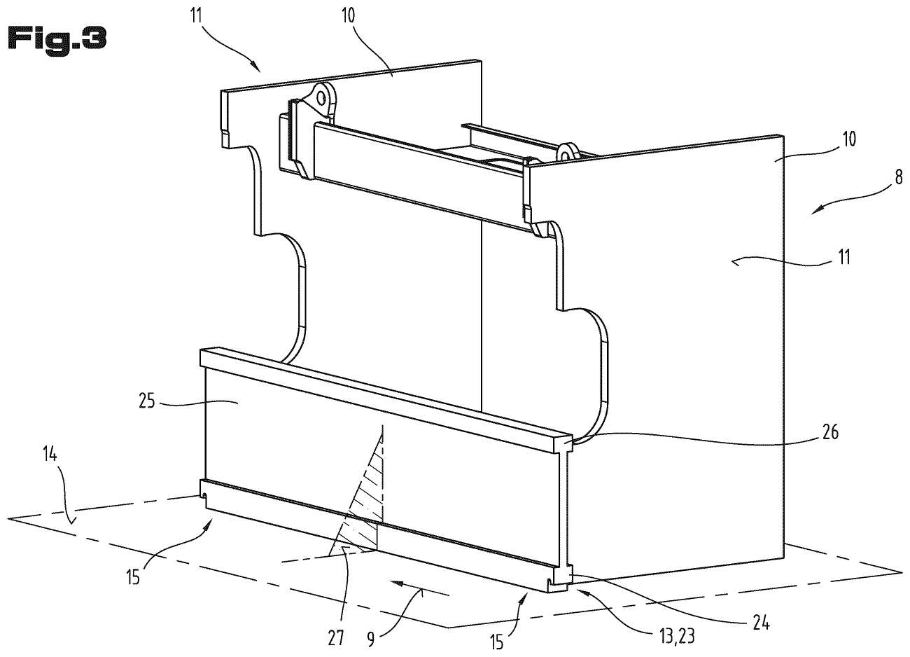

FIG. 3 a possible configuration form of the machine frame with a beam-like supporting structure of the machine table;

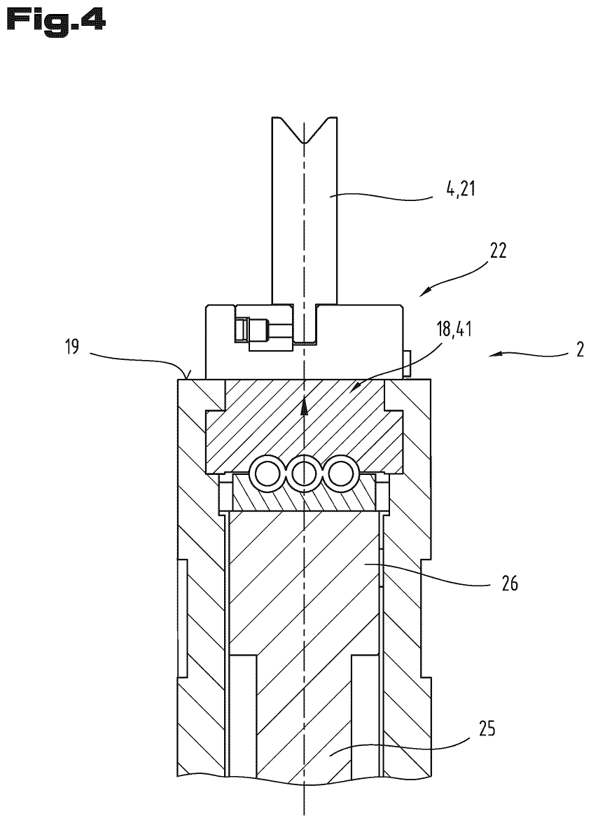

FIG. 4 a partial section through a possible configuration form of a machine table of the bending machine in a cross-sectional plane;

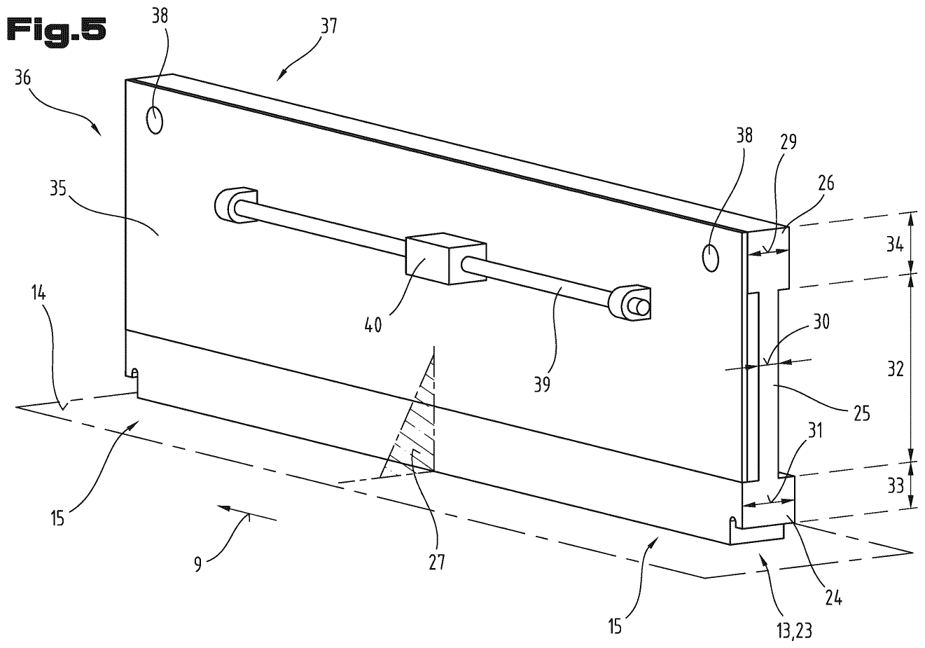

FIG. 5 a possible configuration form of the beam-like supporting structure with a plate element.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 to FIG. 5 show a bending machine 1 and system components of the bending machine 1 as well as a partial section through a possible configuration form of a machine table 2 of the bending machine 1 in a highly simplified schematic representation, which bending machine 1 in the present case is configured in particular for the free bending of workpieces 3 to be manufactured from sheet metal by means of die bending or by means of a bending-pressing operation or a folding-pressing operation. The starting material is usually a metallic material, which in its undeformed state may be described as a flat material or flat element. In FIG. 1, some system components of the bending machine 1 are not shown for the sake of clarity.

The bending machine 1 comprises a stationary machine frame 8 with two frame faces 10 spaced apart in the longitudinal direction 9. The frame faces 10 each have an outer surface 11, the frame faces 10 being positioned at a distance from one another in such a way that the outer surfaces 11 are aligned normal to the longitudinal direction 9.

In conjunction with FIG. 1, FIG. 2 shows the front view of the bending machine 1, which can be used to perform rectilinear bending or, in special cases, the forming of free surfaces on a workpiece 3. For this purpose, the bending machine 1 comprises two pressing beams that are adjustable relative to each other and act on the workpiece 3 with bending tools in the form of a bending punch and a bending die. The lower stationary pressing beam shown in FIG. 1 and FIG. 2 is referred to below as machine table 2, which together with a bending die 4 serves as a support for the workpiece 3 and interacts with the adjustable pressing beam 5 and a bending punch 6 arranged on it. The pressing beam 5 is adjustably mounted on the stationary machine frame 8 of the bending machine 1 by means of a guide arrangement 7 or guide arrangements 7 and is driven by a drive means 12, for example in the form of hydraulic cylinders.

As FIG. 2 shows, an elastic deformation 16 or deflection, indicated by a stroke-dotted line, will generally occur on the pressing beam 5 during a bending operation, as the lines of action of the forces of the drive means 12 and the force exerted by the workpiece 3 on the pressing beam 5 do not coincide. Deformation 16 or deflection is also possible on the machine table 2, as the lines of action of the forces exerted by the workpiece 3 on the machine table 2 and the forces exerted by a contact surface 14 on the machine table 2 do not coincide. It is conceivable that the bending machine 1 is mounted on a total of four support surfaces of the frame faces 10 on the contact surface 14. Accordingly, the deformation 16 can affect the entire machine table 2.

Such a deformation 16 or deflection of the pressing beam 5 or machine table 2 has the effect that a workpiece 3 is pressed less deeply into the bending die 4 by the bending punch 6 of machine table 2 in the middle of the edge to be bent than at the ends of the bending edge, which is why different bending angles can result on the bent workpiece 3 along the bending edge and such a workpiece 3 may have to be reworked or cannot be used. The forces 17 causing the respective deformation 16 or deflection are shown in simplified form by arrows in FIG. 2 on the machine table 2 or on the pressing beam 5.

To avoid the adverse effects on a workpiece 3 due to deformation 16 of the machine table 2 or the press beam 5, it is known from the state of the art to provide active countermeasures on the machine table 2 in this respect. For example, a uniform penetration depth of the bending punch 6 into a workpiece 3 may be achieved by actively causing a crowning on the machine table 2 by means of an adjusting device 18 to compensate for a deformation 16 on the pressing beam 5, which approximately corresponds to the deformation 16 on the pressing beam 5.

Due to the deformation 16, a concave second support surface 20 of the pressing beam 5 interacts with a convex, crowned first support surface 19 of the machine table 2, resulting in a uniform penetration depth of the bending punch 6 into the workpiece 3 along the bending edge and thus also a largely constant bending angle along the bending edge. The first support surface 19 and the second support surface 20 are provided for supporting bending tools 21, such as a bending die 4 or a bending punch 6, or tool holding devices 22 for bending tools 21, so that the crowning of the previous description may be transferred accordingly.

Possible embodiments of a machine table 2 according to the invention are described below, wherein the structural features and measures may also be transferred analogously to an adjustable pressing beam 5 and thus the support surface for a bending die 4 or a bending punch 6 can be actively adjusted from a flat starting position to a convex, outwardly curved shape not only in the case of a machine table 2 but also in the case of a pressing beam 5.

FIG. 3 shows a possible configuration form of the machine frame 8 with a beam-like supporting structure 13 of the machine table 2. The supporting structure 13 is fixedly positioned on the contact surface 14 and extends along the longitudinal direction 9. At the end areas 15 of the beam-like supporting structure 13, which are spaced apart from each other in the longitudinal direction 9, it is connected to the frame faces 10. It may be provided that the frame faces 10 have a total of four support surfaces, by means of which the machine frame 8 is positioned or mounted on the contact surface 14.

The beam-like supporting structure 13 is configured as a one-piece welded construction 23, which one-piece welded construction 23 may be composed of individual elements or may be formed by welding together individual elements. The individual elements may comprise at least one lower chord element 24 and at least one web element 25. The individual elements may also comprise at least one upper chord element 26.

The dimensions of the individual elements, namely at least the cross-sectional dimensions of the individual elements in a cross-sectional plane 27 normal to the longitudinal direction 9, may be selected in such a way that, in manufacturing bending machines, such as the bending machine 1 according to the invention, with a substantially equal or identical machine table length 28 in the longitudinal direction 9 and with different pressing forces 17, essentially the same deformations 16 or deflections of at least the first support surface 19 occur during the bending-pressing operation or during the folding-pressing operation, wherein a total deformation relating to the pressing beam 5 and the machine table 2 is decisive for the identically set deformation 16. This makes it possible to install or use essentially identical or essentially identical or very similar adjusting devices 18 for crowning at least the first support surface 19, in each case for the bending machines 1 with different pressing forces 17 and almost identical machine table lengths 28.

The cross-sectional dimensions of the individual elements may include an upper chord element width 29, a web element width 30, a lower chord element width 31 as well as a web height 32, a lower chord height 33 and an upper chord height 34.

With regard to crowning, the machine table 2 may comprise an adjusting device 18. The adjusting device 18 may be used to actively adjust the first support surface 19 between a substantially flat and a crowned course of the first support surface 19. The first support surface 19 may be formed by a first beam element 41 of the machine table 2.

Irrespective of this, it may be provided that not only one web element 25, but a plurality of web elements 25 is provided, wherein the plurality of web elements 25 are lined up along the longitudinal direction 9 and form the one-piece welded construction 23. A possible configuration form of the beam-like supporting structure 13 is conceivable in which the individual multiple web elements 25 each have a different web element width 30. Another possible configuration form is also conceivable, in which the multiple web elements 25 are arranged at a distance from one another along the longitudinal direction 9. Combinations of the two configuration forms are also conceivable. In any case, a desired deformation behavior or a desired deformation 16 of the beam-like supporting structure 13 during the folding-pressing operation can be achieved in a simple and cost-effective manner. Furthermore, the beam-like supporting structure 13 is in any case manufactured as a one-piece welded construction 23 from the individual elements, which also comprise the plurality of web elements 25. Preferably, it may also be provided that an odd number of the plurality of web elements 25 is provided. In any case, a supporting effect is realized in the middle area of the bending edge by a web element 25. It may be provided that the centrally arranged web element 25 has a greater web element width 30 relative to the further web elements 25 spaced from the central web element 25 in the direction of the end regions 15 of the beam-like supporting structure 13.

The beam-like supporting structure 13 may have a first longitudinal side 36 and a second longitudinal side 37, wherein the first longitudinal side 36 is opposite the second longitudinal side 37 and wherein the second longitudinal side 37 is closest to the machine frame 8. At least one plate element 35, which is enclosed by the machine table 2, may be arranged on the first longitudinal side 36. The at least one plate element 35 covers the beam-like supporting structure 13 at least in sections and can be connected to the beam-like supporting structure 13 by means of a fastening means 38, such as one or more screws, preferably detachably if necessary.

It may also be provided that the first longitudinal side 36 is covered by a plurality of plate elements 35, wherein the plurality of plate elements 35 can each be connected to the beam-like supporting structure 13 by fastening means 38. The plate element 35 or each plate element 35 of the plurality of plate elements 35 may have a holding or guiding device 39, or a holding or guiding device 39 may be positioned or held on the plate element 35, which holding or guiding device 39 may be provided for holding an additional unit 40. An additional unit 40 may be, for example, a workpiece support unit, a bending angle measuring device or a workpiece support. Furthermore, as described above, it may be provided that the second longitudinal side 37 is covered by a plate element 35 or also by a plurality of plate elements 35, wherein the plurality of plate elements 35 may each be connected to the beam-like supporting structure 13 by fastening means 38. It is also conceivable that plate elements 35, which cover the first longitudinal side 36, are coupled to plate elements 35, which cover the second longitudinal side 37, so that a clear reference to one another can be established, for example in order to use additional units 40 in a correspondingly position-related manner.

Analogically to the configuration of the beam-like supporting structure 13 of the machine table 2, the pressing beam 5 may comprise a pressing beam supporting structure 42, wherein the pressing beam supporting structure 42 may be configured in the same way as the beam-like supporting structure 13 as a further one-piece welded construction 43 like the one-piece welded construction 23 made of individual elements.

Analogically to the machine table 2, the pressing beam 5 may comprise a second adjusting device 44 for actively adjusting the second support surface 20 between a substantially flat and a crowned course of the second support surface 20.

If the dimensions of the individual elements of the pressing beam supporting structure 42 and beam-like supporting structure 13 are configured accordingly to achieve the intended deformation 16 during the folding-pressing operation, the same or a structurally similar adjusting device 18 may be used for both the pressing beam 5 and the machine table 2.

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions can be taken from the description.

Finally, as a matter of form, it should be noted that for ease of understanding of the structure, elements are partially not depicted to scale and/or are enlarged and/or are reduced in size.

### LIST OF REFERENCE SIGNS

| | |
|---|---|
| 1 | bending machine |
| 2 | machine table |
| 3 | workpiece |
| 4 | bending die |
| 5 | pressing beam |
| 6 | bending punch |
| 7 | guide arrangement |
| 8 | machine frame |
| 9 | longitudinal direction |
| 10 | frame face |
| 11 | outer surface |
| 12 | drive means |
| 13 | supporting structure |
| 14 | contact surface |
| 15 | end areas |
| 16 | deformation |
| 17 | pressing forces |
| 18 | adjusting device |
| 19 | first support surface |
| 20 | second support surface |
| 21 | bending tool |
| 22 | tool holding device |
| 23 | one-piece welded construction |
| 24 | lower chord element |
| 25 | web element |
| 26 | upper chord element |
| 27 | cross-sectional plane |
| 28 | machine table length |
| 29 | upper chord element width |
| 30 | web element width |
| 31 | lower chord element width |
| 32 | web height |
| 33 | lower chord height |
| 34 | upper chord height |
| 35 | plate element |
| 36 | first longitudinal side |
| 37 | second longitudinal side |
| 38 | fastening means |
| 39 | holding or guiding device |
| 40 | additional unit |
| 41 | first beam element |
| 42 | pressing beam supporting structure |
| 43 | further one-piece welded construction |
| 44 | second adjusting device |
| 45 | pressing beam length |

1. A bending machine (1) for producing workpieces (3) from sheet metal by forming in a bending-pressing operation or a folding-pressing operation, comprising
a machine frame (8) comprising two frame faces (10) spaced apart from one another in a longitudinal direction (9), wherein respective outer surfaces (11) of the frame faces (10) are aligned normal to the longitudinal direction (9),
a machine table (2) comprising a beam-like supporting structure (13), the beam-like supporting structure (13) being fixed on a contact surface (14), extending along the longitudinal direction (9) and being connected to a respective frame face (10) of the machine frame (8) at its end regions (15) which are spaced apart from one another in the longitudinal direction (9),
a pressing beam (5) adjustable along guide arrangements (7) on the machine frame (8) and aligned along the longitudinal direction (9), the pressing beam (5) being adjustable in the direction towards and away from the machine table (2) by at least one drive means (12),
a first support surface (19) on the machine table (2) and a second support surface (20), opposite the first support surface (19), on the pressing beam (5) for bending tools (21) and/or for tool holding devices (22) which can be fitted with bending tools (21),
wherein the beam-like supporting structure (13) comprises at least one lower chord element (24) and at least one web element (25), wherein the at least one lower chord element (24) and the at least one web element (25) configure a one-piece welded construction (23),
wherein the beam-like supporting structure (13) comprises an odd number, in particular three, five or seven, preferably three, of web elements (25) arranged in a row in the longitudinal direction (9),
wherein
a cross-sectional plane (27) is defined normal to the longitudinal direction (9), and wherein the web elements (25), which are closest to the end regions (15) of the beam-like supporting structure (13), have a smaller web element width (30) in the cross-sectional plane (27) in the direction parallel to the contact surface (14) than the web element (25) arranged centrally in the longitudinal direction (9) of the beam-like supporting structure (13).

2. The bending machine (1) according to claim 1, wherein the beam-like supporting structure (13) further comprises at least one upper chord element (26) which forms the one-piece welded construction (23) with the at least one web element (25).

3. The bending machine (1) according to claim 2, wherein a cross-sectional plane (27) is defined normal to the longitudinal direction (9), and wherein the upper chord element (26) in the cross-sectional plane (27) has an upper chord element width (29) in the direction parallel to the contact surface (14), the upper chord element width (29) in the cross-sectional plane (27) being greater than a web element width (30) in the direction parallel to the contact surface (14) of the at least one web element (25).

4. The bending machine (1) according to claim 1, wherein a cross-sectional plane (27) is defined normal to the longitudinal direction (9), and wherein the lower chord element (24) has a lower chord element width (31) in the cross-sectional plane (27) in the direction parallel to the contact surface (14), the lower chord element width (31) in the cross-sectional plane (27) being greater than a web element width (30) in the direction parallel to the contact surface (14) of the at least one web element (25).

5. The bending machine (1) according to claim 1, wherein a cross-sectional plane (27) is defined normal to the longitudinal direction (9), and wherein the at least one web element (25) in the cross-sectional plane (27) has a web height (32) in the direction normal to the contact surface (14), the web height (32) in the cross-sectional plane (27) being greater than a lower chord height (33) in the direction normal to the contact surface (14).

6-7. (canceled)

8. The bending machine (1) according to claim 1, wherein the web elements (25) are arranged at a distance from each other in the longitudinal direction (9).

9. The bending machine (1) according to claim 1, wherein the machine table (2) comprises at least one plate element (35), wherein the at least one plate element (35) is arranged on a first longitudinal side (36) of the beam-like supporting structure (13), wherein the first longitudinal side (36) is opposite a second longitudinal side (37) of the beam-like supporting structure (13), and wherein the second longitudinal side (37) is assigned closest to the machine frame (8), and wherein the at least one plate element (35) covers the beam-like supporting structure (13) at least in sections and can be connected to the beam-like supporting structure (13) by means of at least one fastening means (38).

10. The bending machine (1) according to claim 9, wherein the machine table (2) comprises several plate elements (35) that are spaced apart in the longitudinal direction (9) and arranged on the first longitudinal side (36) of the beam-like supporting structure (13).

11. The bending machine (1) according to claim 9, wherein at least one plate element (35) comprises a holding or guiding device (39) for at least one additional unit (40), wherein the at least one additional unit (40) is selected from the group consisting of workpiece support unit, bending angle measuring device and workpiece support.

12. The bending machine (1) according to claim 1, wherein the machine table (2) comprises an adjusting device (18) for actively adjusting the first support surface (19) between a substantially flat and a crowned course of the first support surface (19), wherein the first support surface (19) is formed by a first beam element (41) of the machine table (2) and is supported on the beam-like supporting structure (13).

13. The bending machine (1) according to claim 1, wherein the pressing beam (5) comprises a pressing beam supporting structure (42), which pressing beam supporting structure (42), like the beam-like supporting structure (13), is configured as a further one-piece welded construction (43) comprising at least one further lower chord element and at least one further web element.

14. The bending machine (1) according to claim 13, wherein the pressing beam (5) comprises a second adjusting device (44) for actively adjusting the second support surface (20) between a substantially flat and a crowned course, wherein the second support surface (20) is formed by a second beam element of the pressing beam (5) and is supported on the pressing beam supporting structure (42).

15. A method for manufacturing bending machines (1), a bending machine (1) comprising
a machine frame (8) comprising two frame faces (10) spaced apart from one another in a longitudinal direction (9), wherein respective outer surfaces (11) of the frame faces (10) are aligned normal to the longitudinal direction (9),
a machine table (2) having a machine table length (28) in the longitudinal direction (9), the machine table (2) comprising a beam-like supporting structure (13), the beam-like supporting structure (13) being positioned fixedly on a contact surface (14), extending along the longitudinal direction (9) and being connected to a respective frame face (10) of the machine frame (8) at its end regions (15) spaced apart from one another in the longitudinal direction (9),
a pressing beam (5) adjustable along guide arrangements (7) on the machine frame (8) and aligned along the longitudinal direction (9) and having a pressing beam length (45) extending in the longitudinal direction (9), the pressing beam (5) being adjustable by at least one drive means (12) in the direction towards and away from the machine table (2),
a first support surface (19) on the machine table (2) and a second support surface (20) opposite the first support surface (19) on the pressing beam (5), in each case for bending tools (21) and/or for tool holding devices (22) which can be fitted with bending tools (21),
wherein the beam-like supporting structure (13) is formed from individual elements, which individual elements comprise at least one lower chord element (24) and at least one web element (25), a one-piece welded construction (23) being formed from the individual elements,
wherein the individual elements of the one-piece welded construction (23) are dimensioned by bending machines (1) with a substantially identical machine table length (28) in such a way that the first support surface (19) has a substantially identical deformation (16) of the first support surface (19) or a substantially identical sum deformation of the first support surface (19) and the second support surface (20) independently of the pressing forces (17) which can be applied by means of the drive means (12) of the bending machine (1) during the bending-pressing operation or the folding-pressing operation, and
wherein the individual elements are welded together to form the one-piece welded construction (23),
wherein further web elements (25) are provided as further individual elements for the one-piece welded construction (23), wherein a total of three, five or seven web elements (25) arranged in a row in the longitudinal direction (9) are provided for the one-piece welded construction (23),
wherein
a cross-sectional plane (27) is defined normal to the longitudinal direction (9), wherein the web elements (25) which are closest to the end regions (15) of the beam-like supporting structure (13) are those web elements (25) which have a smaller web element width (30) in the cross-sectional plane (27) in the direction parallel to the contact surface (14) than the web element (25) arranged centrally in the longitudinal direction (9) of the beam-like supporting structure (13).

16-17. (canceled)

18. The method for manufacturing bending machines (1) according to claim 15, wherein the pressing beam (5) comprises a pressing beam supporting structure (42), which pressing beam supporting structure (42), like the beam-like supporting structure (13), is formed as a further one-piece welded construction (43) of individual elements, the individual elements of the further one-piece welded construction (23) being dimensioned by bending machines (1) with a substantially identical press beam length (45) in such a way that the second support surface (20) has a substantially identical deformation (16) of the second support surface (20) or a substantially identical sum deformation of the first support face (19) and the second support surface (20) independently of a pressing force (17) which can be applied by means of the drive means (12) of the bending machine (1) during the bending-pressing operation or the folding-pressing operation, and wherein the individual elements are welded together to form a further one-piece welded construction (23).

19. The method for manufacturing bending machines (1) according to claim 15, wherein an upper chord element (26) is provided as a further individual element for the one-piece welded construction (23).
